(19) United States
(12) Patent Application Publication
(10) Pub. No.: US 2014/0334687 A1
(43) Pub. Date: Nov. 13, 2014

(54) MEDICAL IMAGE ANALYSIS APPARATUS, METHOD AND MEDICAL IMAGING DEVICE

(71) Applicants: Kabushiki Kaisha Toshiba, Minato-ku (JP); Toshiba Medical Systems Corporation, Otawara-shi (JP)

(72) Inventors: Minfeng Xu, Beijing (CN); Chao Cong, Beijing (CN); Hong Yang, Beijing (CN)

(73) Assignees: Kabushiki Kaisha Toshiba, Minato-ku (JP); Toshiba Medical Systems Corporation, Otawara-shi (JP)

(21) Appl. No.: 14/276,013

(22) Filed: May 13, 2014

(30) Foreign Application Priority Data
May 13, 2013 (CN) 201310174117.7

(51) Int. Cl. G06T 7/00

(52) U.S. Cl. CPC G06T 7/0016; G06T 2207/30048
USPC 382/107

(57) ABSTRACT

A medical image analysis apparatus according to an embodiment includes an area motion analysis section and an object motion analysis section. The area motion analysis section configured to carry out a motion analysis on an area including an adjacent tissue of an object in a dynamic image to obtain the motion vector of the adjacent tissue. The object motion analysis section configured to determine the motion vector of the object based on the motion vector of the adjacent tissue.

### CROSS-REFERENCE TO RELATED APPLICATIONS

This application is based upon and claims the benefit of priority from Chinese Patent Application No. 201310174117.7, filed on May 13, 2013, the entire contents of which are incorporated herein by reference.

### FIELD

The present invention relates to the field of medical imaging, and more particularly to a medical image analysis apparatus, a medical image analysis method and a medical imaging device comprising the medical image analysis apparatus.

### BACKGROUND

With the development of the medical imaging technology, a dynamic image (below, it is described also as a dynamic medical image) of an object may be obtained through a plurality of imaging methods. The movement situation of a moving organ may be determined by analyzing a dynamic medical image. How to determine the movement situation of a specific organ based on the dynamic medical image becomes an important subject.

### BRIEF DESCRIPTION OF THE DRAWINGS

FIG. 1 is a block diagram illustrating an exemplary configuration of a medical image analysis apparatus according to an embodiment of the present invention;

FIG. 2 is a block diagram illustrating an exemplary configuration of an object motion analysis section included in the medical image analysis apparatus according to an embodiment of the present invention;

FIG. 3 is a block diagram illustrating an exemplary configuration of an area motion analysis section included in the medical image analysis apparatus according to an embodiment of the present invention;

FIGS. 4A to 4C are schematic diagrams illustrating the principle of a analysis on myocardium of left ventricle motion serving as an application example of the medical image analysis apparatus according to an embodiment of the present invention;

FIG. 5 is a block diagram illustrating an exemplary configuration of the medical image analysis apparatus according to an embodiment of the present invention;

FIG. 6 is a schematic diagram illustrating the principle of determining rotation amount of the object;

FIGS. 7A to 7D are diagrams illustrating an exemplary analysis result on the left ventricular myocardium motion obtained by the medical image analysis apparatus according to an embodiment of the present invention;

FIG. 8 is a flow chart illustrating an exemplary process of the medical image analysis method according to an embodiment of the present invention;

FIG. 9 is a flow chart illustrating an exemplary processing of the step for determining the motion vector of the object included in the medical image analysis method according to an embodiment of the present invention;

FIG. 10 is a flow chart illustrating an exemplary processing of the medical image analysis method for left ventricular myocardium according to an embodiment of the present invention;

FIG. 11 is a block diagram illustrating an exemplary configuration of a medical imaging device according to an embodiment of the present invention; and

FIG. 12 is a block diagram illustrating an exemplary structure of a computer capable of realizing embodiments/examples of the present invention.

### DETAILED DESCRIPTION

A simplified summary of the present invention is given below to provide a basic understanding of some aspects of the present invention. It should be appreciated that the summary, which is not an exhaustive overview of the present invention, is not intended to identify the key or critical parts of the present invention or limit the scope of the present invention, but merely to present some concepts in a simplified form as a prelude to the more detailed description that is discussed later.

According to an aspect of the present invention, a medical image analysis apparatus includes: an area motion analysis section configured to carry out a motion analysis on an area including an adjacent tissue of an object in a dynamic image so as to obtain the motion vector of the adjacent tissue; and an object motion analysis section configured to determine the motion vector of the object based on the motion vector of the adjacent tissue.

According to another aspect of the present invention, a medical image analysis method includes the steps of: carrying out a motion analysis on an area including an adjacent tissue of an object in a dynamic image so as to obtain the motion vector of the adjacent tissue; and determining the motion vector of the object based on the motion vector of the adjacent tissue.

According to still another aspect of the present invention, there is provided a medical imaging device which includes the medical image analysis apparatus described above.

According to yet another aspect of the present invention, there is provided a program product storing machine readable instruction codes. A computer, when reading and executing the instruction codes, may execute the aforementioned medical image analysis method according to embodiments of the present invention or serve as the aforementioned medical image analysis apparatus according to embodiments of the present invention.

According to still yet aspect of the present invention, there is provided a storage medium carrying the aforementioned program product storing the machine readable instruction codes.

Preferred embodiments of the present invention are described below with reference to accompanying drawings. The elements and features described in one of the accompanying drawings or implementation modes of the present invention may be combined with those shown in one or more other accompanying drawings or implementation modes. It should be noted that for the sake of clarity, the presentation and description on the elements and processing that are irrelative with the present invention but well known by those skilled in the art are omitted.

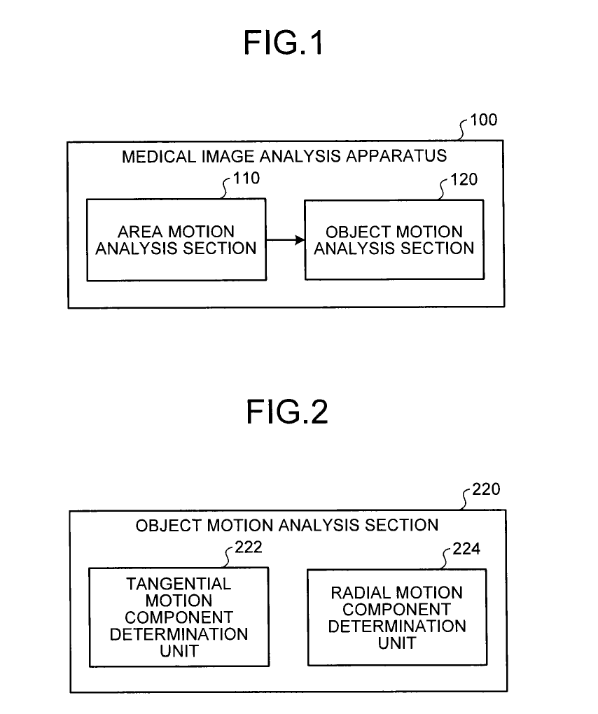

As shown in FIG. 1, the medical image analysis apparatus 100 according to embodiments of the present invention includes an area motion analysis section 110 and an object motion analysis section 120. The area motion analysis section 110 is configured to carry out a motion analysis on an area including an adjacent tissue of an object in a dynamic image so as to obtain the motion vector of the adjacent tissue. The object motion analysis section 120 is configured to determine the motion vector of the object based on the motion vector of the adjacent tissue determined by the area motion analysis section 110.

An analysis object for the medical image analysis apparatus according to embodiments of the present invention may be any moving organ, such as muscle, joint and the like.

In addition, a dynamic medical image of the object may be obtained through a plurality of medical imaging methods, for example, magnetic resonance imaging (MRI), X-ray imaging, ultrasound (UL) diagnostic imaging, computed tomography (CT), positron emission tomography (PET) and the like.

For some moving organs serving as an analysis object, due to relatively consistent tissue features of each own part thereof, an image area corresponding to the object may not have the features easy to be recognized, thus it is difficult to obtain sufficiently accurate motion analysis result based on a motion image of the object. However, the medical image analysis apparatus according to embodiments of the present invention, by carrying out a motion analysis on an area including an adjacent tissue of the object and determining the motion vector of the object based on the motion vector of the adjacent tissue, may make full use of the feature of the adjacent tissue of the object to obtain the motion analysis result of the object more accurately.

In addition, the motion of the moving organ, such as muscle, joint and the like, may include concertina motion, rotation motion or a combination thereof. In other words, the motion of the object may include radial (or normal) component and tangential (or rotate) component.

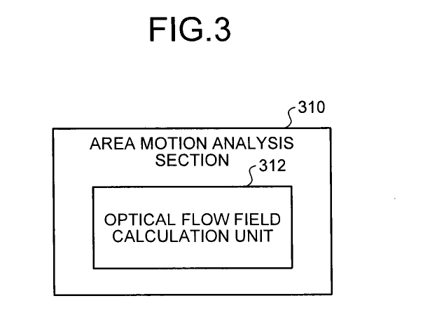

Accordingly, as shown in FIG. 2, in accordance with an embodiment of the present invention, the object motion analysis section 220 may include a tangential motion component determination unit 222 and a radial motion component determination unit 224, which are configured to determine tangential motion component and radial motion component of the object, respectively. In other words, the object motion analysis section 220 determines the object movement by combining the tangential motion component with the radial motion component.

Wherein, the tangential motion component determination unit 222 may determine the tangential motion component of the object based on the tangential components of the motion vector of the adjacent tissue obtained by the area motion analysis section described above. Similarly, radial motion component determination unit 224 may determine the radial motion component of the object based on the radial components of the motion vector of the adjacent tissue obtained by the area motion analysis section described above.

Alternatively, the radial motion component determination unit 224 may, by carrying out the motion analysis on the profile of the object, determine the radial motion component of the object.

According to the motion analysis on the profile, the concertina motion, namely, radial motion component, of the object may be determined. As compared to the motion analysis of the adjacent tissue, the profile of the object is easier to recognize and the motion analysis of the object requires less amount of calculation. Therefore, the calculation amount required for the motion analysis may be further reduced by determining the radial motion component of the object according to the profile of the object, thereby further increasing the processing efficiency of the medical image analysis apparatus.

According to an embodiment, the radial motion component determination unit may carry out the motion analysis on the profile of the object through feature tracking. It is known that there are a plurality of specific manners for motion analysis on the profile through the feature tracking which are not described in detail herein.

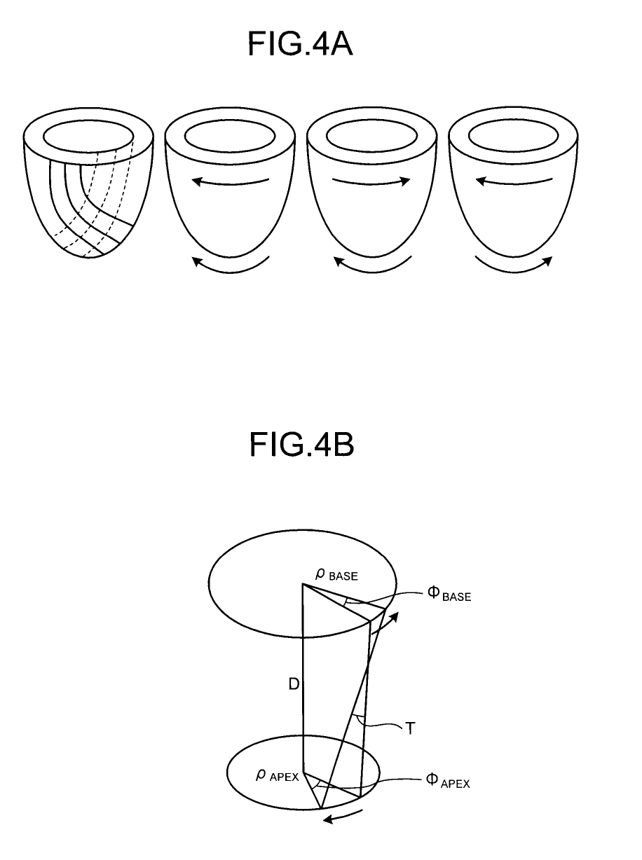

As shown in FIG. 3, according to an embodiment of the present invention, the area motion analysis section 310 includes an optical flow field calculation unit 312 which is configured to, by calculating continuous motion optical flow field of the area including the adjacent tissue of the object in the dynamic image, carry out the motion analysis on the area.

Specifically, for example, the continuous motion optical flow field of the area may be calculated using Lucas-Kanade optical flow algorithm. More particularly, the optical flow field may be calculated using Lucas-Kanade optical flow algorithm based on a pyramid pattern, thereby obtaining the calculation result of the optical flow field more efficiently. The specific manner used for calculating the optical flow field through the aforementioned algorithm is known, and is not described in detail herein.

However, the motion analysis method employed by the present invention is not limited to this, and the motion analysis on the above-described area may be carried out by other algorithms based on local neighbor constraint. The local neighbor constraint is based on the following understanding: organ tissue (e.g. fiber structure) has regional motion consistency, that is, the change of the motion vector of each part in local neighbor area in a tissue has continuity instead of messiness.

The features contained in the image and the physical property of the organ tissue may be more fully used to determine the motion vector of the object more accurately by using the aforementioned constraint to carry out motion analysis on the area including the adjacent tissue.

Next, the medical image analysis apparatus according to embodiments of the present invention is described through an example by taking the myocardium of left ventricle as a motion organ.

The function of cardiac pump depends on the contraction and relaxation of complex-arranged muscle fibers in the myocardium, while the rotation/distortion of the left ventricle generated by the muscle fibers in spiral orientation is a critical parameter of cardiac function and become more and more important in cardiac function analysis.

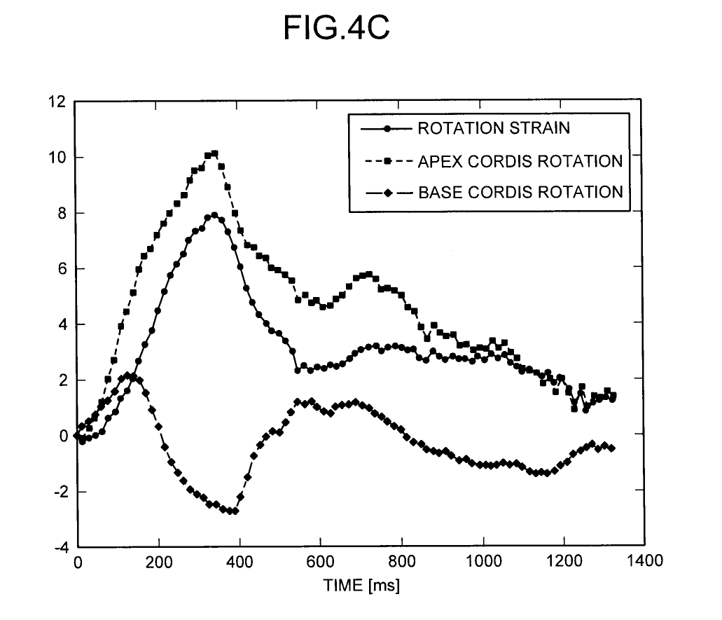

The principle of the motion analysis of the myocardium of left ventricle serving as an application example for the medical image analysis apparatus according to embodiments of the present invention is illustrated with reference to FIGS. 4A, 4B and 4C. As shown in FIG. 4A, in a cardiac cycle, the left ventricle occurs rotation strain about the long axis thereof through opposite-direction rotation movements of basis cordis and apex cordis. As shown in FIG. 4B, the rotation strain of the whole left ventricle may be further determined by determining the rotation angles (φbase and φapex) of the basis cordis and the apex cordis. Further, FIG. 4C is a exemplary graph illustrating time-dependent basis cordis rotation angle, apex cordis rotation angle and rotation strain of the left ventricle determined by the basis cordis rotation angle and the apex cordis rotation angle in the cardiac cycle.

The existing cardiac function analysis method based on the medical image includes determining myocardium shape and left ventricle volume using a segmentation-related method according to a dynamic medical image. However, such method is lack of continuous motion information and cannot detect the rotation motion of the myocardium. In addition, the detection of the rotation motion of the myocardium may be implemented through a special imaging method, such as magnetic resonance tagging (MR tagging) imaging or magnetic resonance phase contrast (MR phase contrast) imaging. However, these special imaging manners are complicated and time-consuming.

In addition, for some dynamic medical images, for example, cine magnetic resonance (cine MR) image, pixel distribution in similar tissues (e.g. myocardium) is also relatively similar, therefore, it is difficult to find out a mark or a spot to serve as a tracking object used in the motion analysis. Particularly, when determining the rotation motion of the object, an analysis result including messy motions in tangential direction based on the existing manner may be obtained, thus it is difficult to determine the tangential motion component of the object accurately.

The medial image analysis apparatus according to embodiments of the present invention may carry out a motion analysis with the myocardium of left ventricle as an object. Wherein, the area motion analysis section may carry out the motion analysis (e.g. optical flow field-based method or feature tracking-based method) on the area including an adjacent tissue of the myocardium of left ventricle in a dynamic image (e.g. cine MR). The adjacent tissue may include, for example, the connection part of left ventricle and right ventricle, pericardium and/or papillary muscles. Wherein, the connection part of left ventricle and the right ventricle and the pericardium are adjacent to the external profile of the myocardium of left ventricle, while the papillary muscles are adjacent to the inner profile of the myocardium of left ventricle.

For example, in a magnetic resonance image, the adjacent tissue has the pixel distribution which is more easily distinguished than that in the myocardium of left ventricle, therefore, the area motion analysis section, through the motion analysis on the area including the above-mentioned adjacent tissue, may carry out the motion analysis on the area more accurately. Accordingly, the object motion analysis section may determine the motion vector of the myocardium of left ventricle according to the motion vector of the adjacent tissue more accurately.

The tangential motion component determination unit and the radial motion component determination unit of the object motion analysis section may determine the tangential component and the radial component of the motion vector of the myocardium of left ventricle based on the motion vector of the connection part of the left ventricle and the right ventricle, the pericardium and/or the papillary muscles obtained by the area motion analysis section.

Alternatively, the tangential motion component determination unit may determine the tangential motion component of the myocardium of left ventricle based on the motion vector of the adjacent tissue, while the radial motion component determination unit may determine the radial motion component of the myocardium of left ventricle by carrying out the motion analysis on the profile of the myocardium of left ventricle.

Specifically, the tangential motion component determination unit may determine the tangential motion component of the myocardium of left ventricle based on the continuous motion optical flow field of the area including the connection part of the left ventricle and the right ventricle, the pericardium and/or the papillary muscles calculated by the optical flow field calculation unit of the area motion analysis section. The radial motion component determination unit may recognize endocardium and epicardium of the myocardium of left ventricle as the inner profile and the external profile of the myocardium of left ventricle, and determine the radial motion of the myocardium of left ventricle by, for example, carrying out the feature tracking to the above-mentioned profile.

It should be noted that the aforementioned dynamic medical image may include a two-dimensional image or a three-dimensional image, accordingly, the various kinds of processing may be implemented using an algorithm corresponding to the two-dimensional image or the three-dimensional image.

When the cardiac function of the myocardium of left ventricle is analyzed based on a two-dimensional dynamic medial image, the motion analysis stated above may be carried out on the cross sectional images obtained respectively at the basis cordis and the apex cordis of left ventricle, and the parameter of the rotation strain of the myocardium of left ventricle is obtained in the manner above with reference to FIGS. 4A, 4B and 4C.

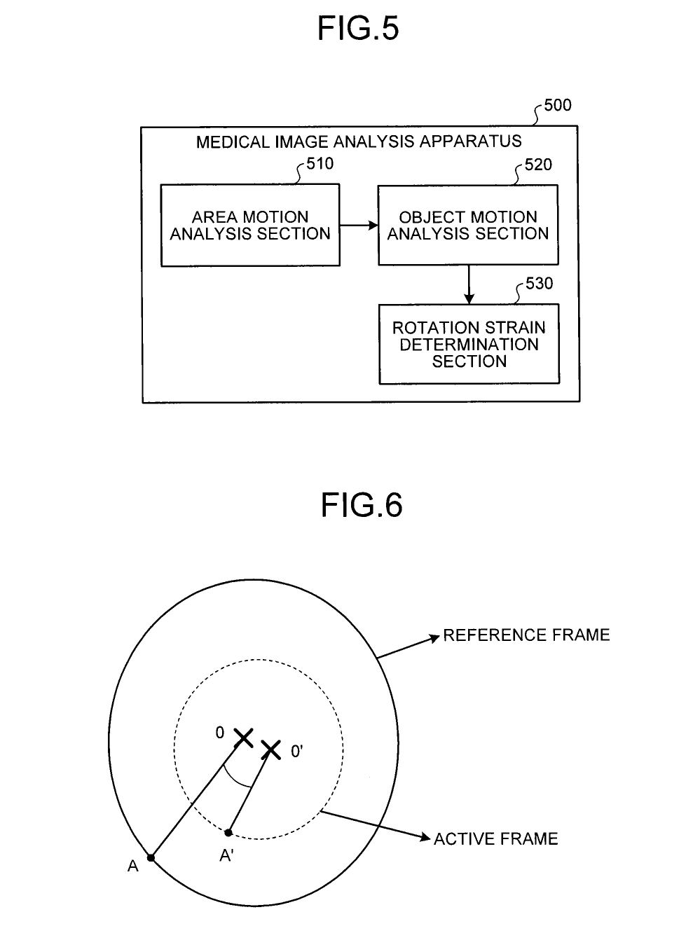

As shown in FIG. 5, the medical image analysis apparatus 500 according to an embodiment of the present invention includes: an area motion analysis section 210, an object motion analysis section 520 and a rotation strain determination section 530.

The configurations of the area motion analysis section 510 and the object motion analysis section 520 are respectively similar to the configurations of the aforementioned area motion analysis section and object motion analysis section, specially, the area motion analysis section 510 and the object motion analysis section 520 may carry out the motion analysis on the two-dimensional dynamic image of the cross section of the basis cordis and the apex cordis of the left ventricle to determine the rotation motion and the concertina motion of the basis cordis and the apex cordis in the process of contraction and/or relaxation of the myocardium. The rotation strain determination section 530 is configured to determine the rotation strain of the myocardium according to the motion vectors of the basis cordis and the apex cordis in the process of contraction and/or relaxation of the myocardium.

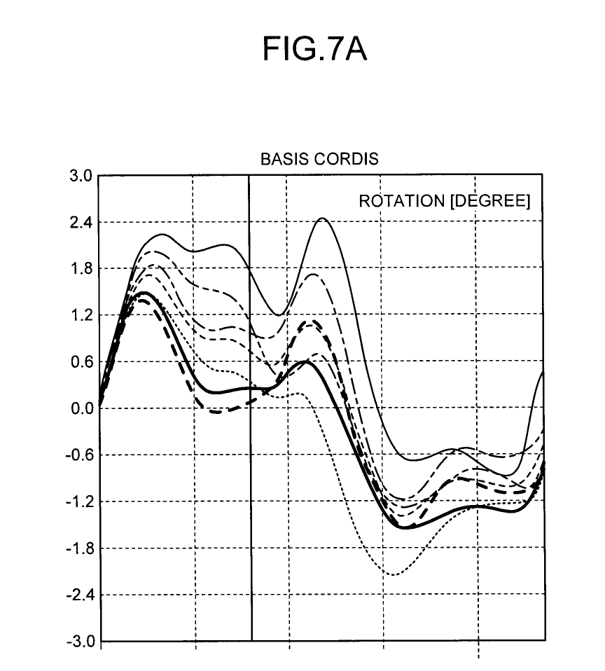

The rotation strain determination section 530 may determine the rotation strain of the myocardium according to the motion vectors of the basis cordis and the apex cordis in a plurality of manners. An example manner for determining rotation amount of an object is described below with reference to FIG. 6. As shown in FIG. 6, it is assumed that the solid line indicates the profile of the object (e.g. endocardium or epicardium) in reference frame, while the dotted line indicates the profile of the object in active frame; A is a point on the profile in the reference frame, A′ is a point corresponding to A on the profile in the active frame, O is the center of the profile of the object in the reference frame, while O′ is the center of the object in the active frame. The rotation angle of the object may be determined through the following Equation 1:

$$θ = {sin}^{- 1} ( \frac{OA * {O}^{′} {A}^{′}}{\vert OA \vert * \vert {O}^{′} {A}^{′} \vert} ) \qquad ( 1 )$$

However, the manner to determine the rotation strain of the object herein is not limited to this specific manner.

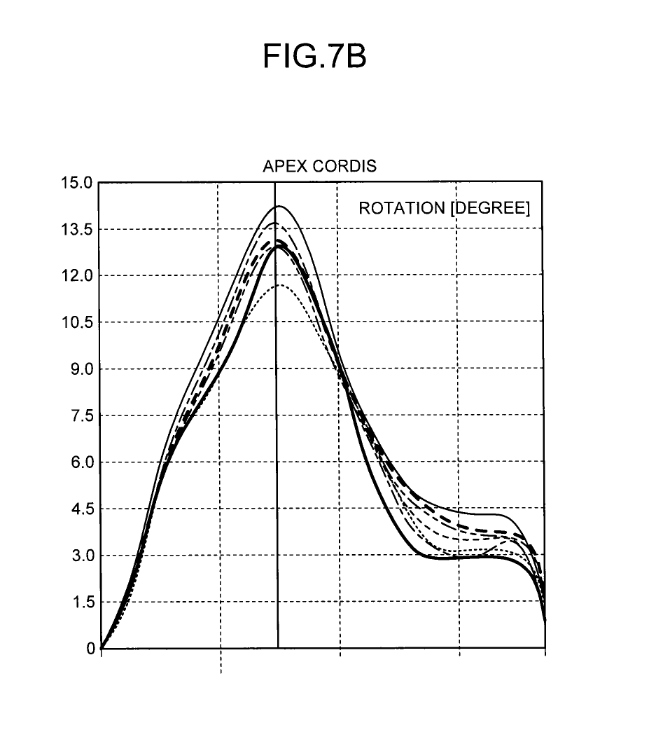

FIGS. 7A, 4B, 4C and 4D illustrates an example of analysis result on the myocardium of left ventricle motion obtained by the medial image analysis apparatus according to embodiments of the present invention. FIGS. 7A and 7B respectively illustrate measure results of rotation of the basis cordis and the apex cordis serving as reference standard obtained in the manner of MR tagging imaging, while FIGS. 7C and 7D respectively illustrate the measure result of rotation of the basis cordis and the apex cordis obtained by the medial image analysis apparatus according to embodiments of the present invention which carries out the motion analysis on an image obtained by ordinary MR imaging.

It can be seen that a result matching with the result obtained in the manner of MR tagging based on an ordinary MR image can be obtained through the medial image analysis apparatus according to embodiments of the present invention. Moreover, as compared with the special imaging manner such as MR tagging, the processing time can be reduced and the processing efficiency can be increased by using the medial image analysis apparatus according to embodiments of the present invention.

It is apparent that some processing or methods are also disclosed in the description above on the medical image analysis apparatus according to embodiments of the present invention. Below, the methods are described roughly without repeating the details which are already discussed above. However, it should be noted that although disclosed in the description of the medical image analysis apparatus, the methods do not necessarily employ or are not necessarily executed by the aforementioned components. For example, embodiments of the medial image analysis apparatus may be partially or completely achieved by hardware and/or firmware, and the medical image analysis methods described below may be fully achieved by a computer-executable program, although the medical image analysis methods may employ the hardware and/or firmware of the medical image analysis apparatus.

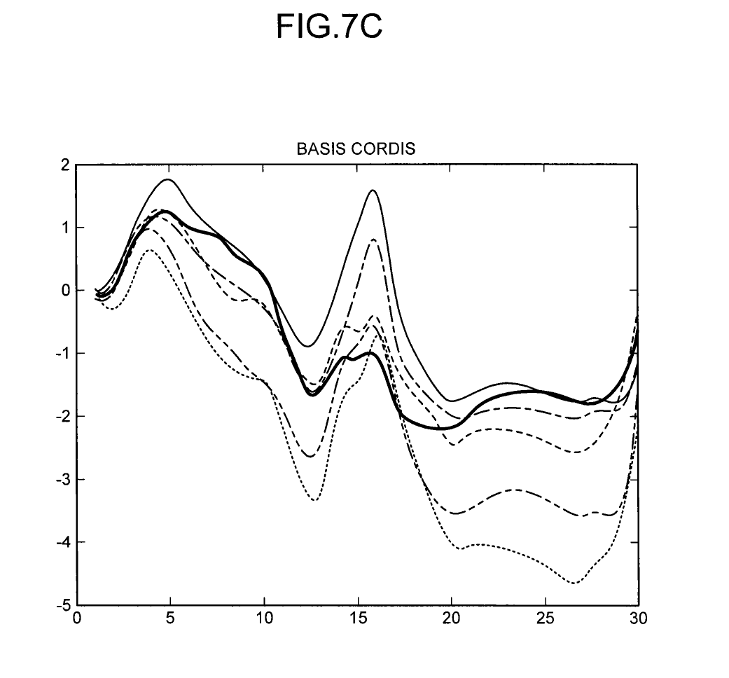

Next, the medical image analysis method is described with reference to FIG. 8 according to an embodiment of the present invention.

As shown in FIG. 8, the method according to the embodiment includes the steps of: carrying out a motion analysis on an area including an adjacent tissue of an object in a dynamic image to obtain the motion vector of the adjacent tissue (Step S820); and determining the motion vector of the object based on the motion vector of the adjacent tissue (Step S830).

When the motion of the object includes a rotation motion and a concertina motion, in Step S830, the tangential motion component and the radial motion component of the object may be respectively determined.

For example, the tangential motion component and the radial motion component of the object may be determined based on the motion vector of the adjacent tissue.

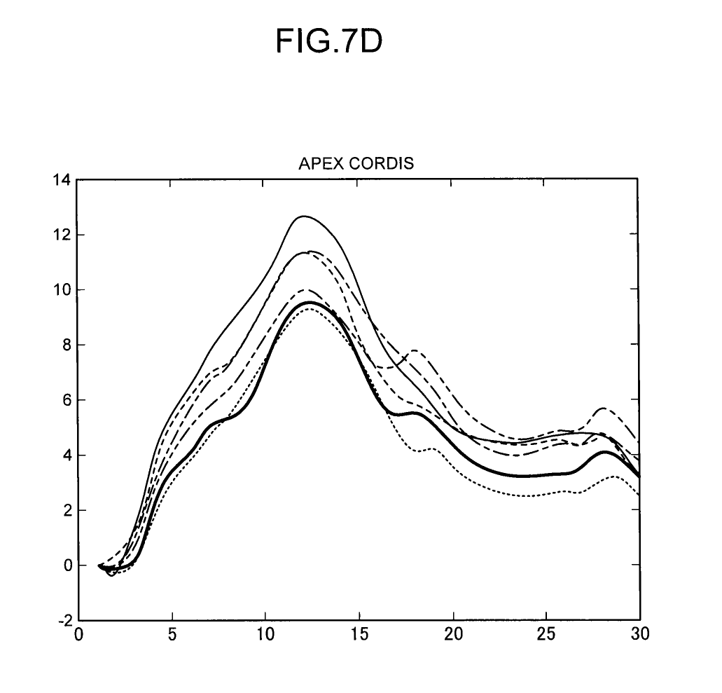

Alternatively, as shown in FIG. 9, the tangential motion component of the object can be determined based on the motion vector of the adjacent tissue (Step S932), while the radial motion component of the object may be determined by carrying out the motion analysis (e.g. through feature tracking) on the profile of the object (Step S934). As mentioned earlier, the calculated amount required for the motion analysis may be further reduced by determining the radial motion component of the object according to the profile of the object, thereby enhancing the processing efficiency of the medical image analysis method further.

Further, in the Step S934 above, the radial motion component of the myocardium of left ventricle may be determined by recognizing the endocardium and the epicardium of the myocardium of left ventricle as the profiles.

Reference back to FIG. 8, in Step S820, the continuous motion optical flow field of the area may be calculated to carry out the motion analysis on the area. There are a plurality of specific optical flow field calculation manners that are not described in detail herein.

By carrying out the motion analysis on the area including the adjacent tissue of the object and determining the motion vector of the object based on the motion vector of the adjacent tissue, the feature of the adjacent tissue of the object may be fully used to obtain the motion analysis result of the object more accurately.

Further, an analysis object for the medical image analysis method according to embodiments of the present invention may include a moving organ. Description will be made below with the myocardium of left ventricle as an exemplary object.

When the object is the myocardium of left ventricle, in Step S820, the adjacent tissue may be determined to include the connection part of the left ventricle and the right ventricle, the pericardium and/or the papillary muscles.

In the analysis on the myocardium of left ventricle, the method according to an embodiment of the present invention may further include a step that the rotation strain of the myocardium is determined according to the motion vectors of the basis cordis and the apex cordis in the process of the contraction and relaxation of the myocardium.

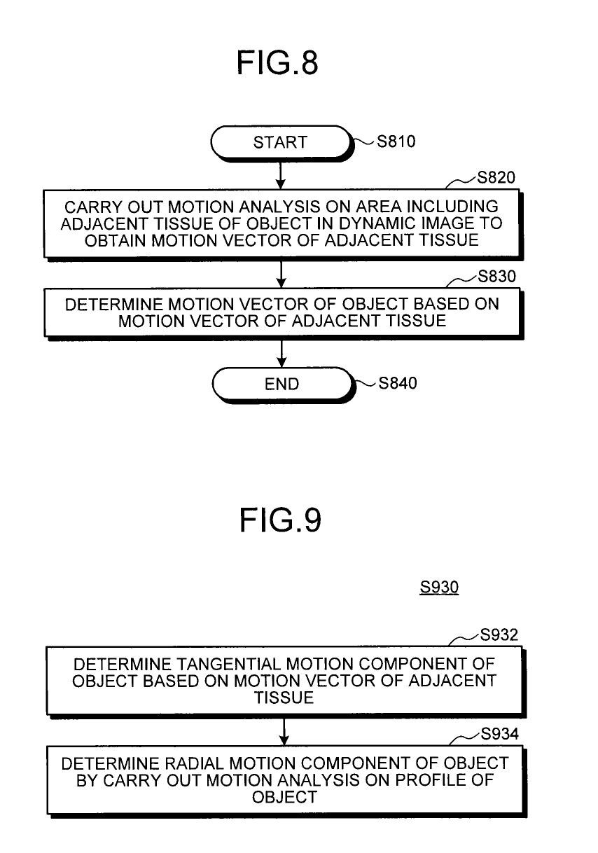

As shown in FIG. 10, in Step S1020, the motion vector of the adjacent tissue of the basis cordis and the apex cordis are respectively determined. In Step S1030, the motion vector of the basis cordis and the apex cordis are respectively determined according to the motion vector of the adjacent tissue determined in Step S1020. Wherein, the processes of Step S1020 and Step S1030 is similar to that of Step S820 and Step S830 described with reference to FIG. 8, and the difference is that the images of the basis cordis and the apex cordis are processed respectively which is not described in detail herein. In Step S1040, the rotation strain of the myocardium is determined according to the motion vectors of the basis cordis and the apex cordis in the process of contraction and/or relaxation of the myocardium, thereby obtaining the information about rotation strain of the myocardium efficiently.

Further, the medical image analysis method according to embodiments of the present invention can be applied to a dynamic image obtained by the following manner, but not limited to: magnetic resonance imaging, X-ray imaging, ultrasonic imaging, computed tomography or positron emission tomography.

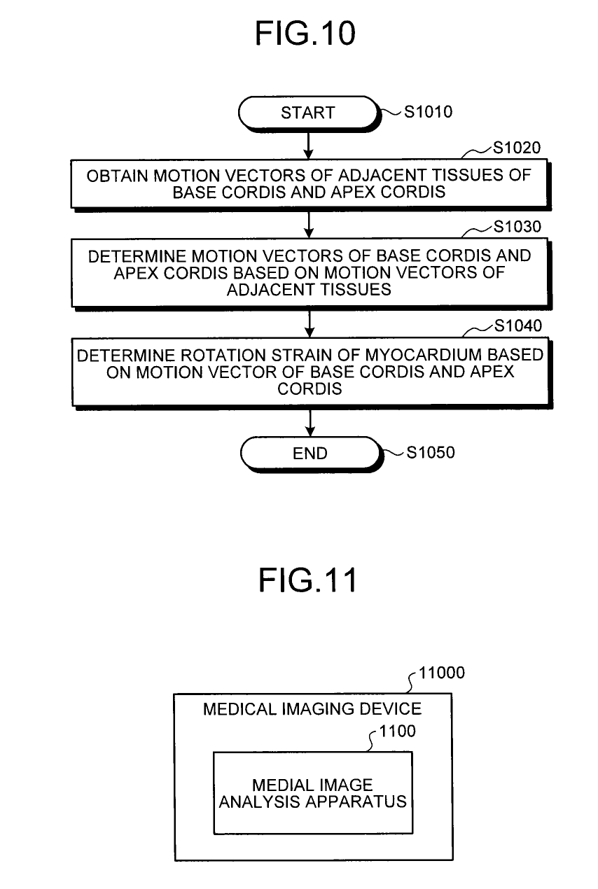

Next, FIG. 11 is a schematic block diagram illustrating a medical imaging device according to another embodiment of the present invention. In order not to obscure the spirit and scope of the present invention, other possible members of the medical imaging device is omitted in FIG. 11. The medical imaging device 11000 includes a medical image analysis apparatus 1100 configured to analyze a dynamic medical image. The medical image analysis apparatus 1100 may be the one described according to any one of embodiments above. The medical imaging device 11000 is, for example, a magnetic resonance imaging diagnostic imaging device, an X-ray imaging diagnostic device, an ultrasonic diagnostic imaging device, a computed tomography device, a positron emission tomography device and the like without limitation.

The medical image analysis apparatus described above may be arranged in a medical imaging device in a specific way or manner that is well known by those skilled in the art and is therefore not described in detail herein.

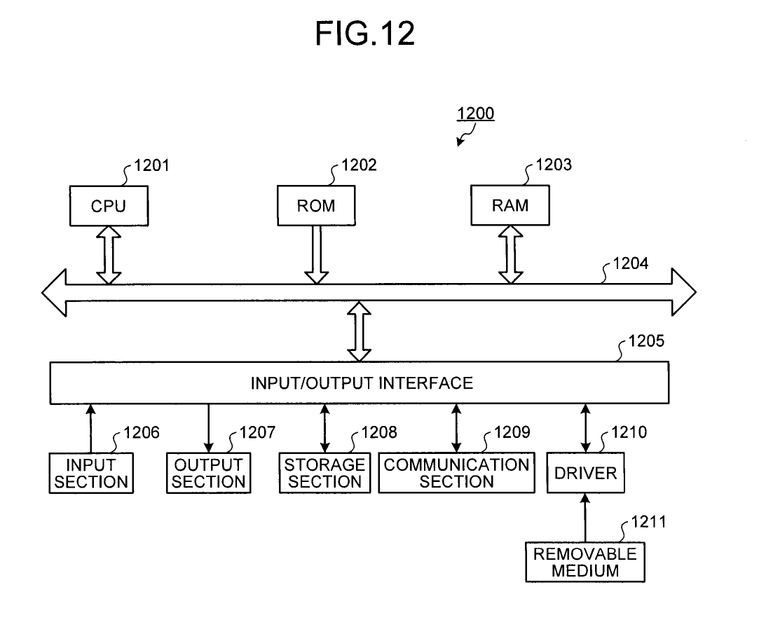

As an example, each action of the aforementioned medical image analysis method and each module and/or unit of the aforementioned medical image analysis apparatus may be implemented as software, firmware, hardware or the combination thereof. In the case where the actions or modules and/or units are achieved through software or firmware, a software program for realizing the aforementioned method is installed in a computer with a specific hardware structure (e.g. the general computer 1200 shown in FIG. 12) from a memory medium or network, and the computer, when installed with a program, is capable of realizing the functions of the program.

In FIG. 12, an operation processing unit (namely, CPU) 1201 executes various processing via a program stored in a read-only memory (ROM) 1202 or a program loaded to a random access memory (RAM) 1203 from a storage section 1208. The data needed for the various processing of the CPU 1201 may be stored in the RAM 1203 as needed. The CPU 1201, the ROM 1202 and the RAM 1203 are linked with each other via a bus 1204, with which an input/output interface 1205 is also connected.

The following members are linked with the input/output interface 1205: an input section 1206 (including keyboard, mouse and the like), an output section 1207 (including displays such as cathode ray tube (CRT), a liquid crystal display (LCD) and loudspeaker), a storage section 1208 (including hard disc and the like), and a communication section 1209 (including a network interface card such as LAN card and modem). The communication section 1209 realizes a communication processing via a network such as the Internet. A driver 1210 may also be connected with the input/output interface 1205, if needed. A removable medium 1211, for example, a magnetic disc, an optical disc, a magnetic optical disc, a semiconductor memory and the like, may be installed in the driver 1210 as needed, such that a computer program read therefrom is installed into the storage section 1208 as needed.

In the case where the foregoing series of processing is achieved through software, programs forming the software are installed from a network such as the Internet or a memory medium such as the removable medium 1211.

It should be appreciated by those skilled in the art that the memory medium is not limited to the removable medium 1211 shown in FIG. 12, which is distributed separated from the apparatus so as to provide the programs for users. The removable medium 1211 may be, for example, a magnetic disc (including floppy disc (registered trademark)), a compact disc (including compact disc read-only memory (CD-ROM) and digital video disc (DVD), a magneto optical disc (including mini disc (MD) (registered trademark))), and a semiconductor memory. Alternatively, the memory medium may be the hard discs included in ROM 1202 and the storage section 1208, in which programs are stored that can be distributed to users along with the memory medium.

The present invention further discloses a program product in which machine-readable instruction codes are stored. The aforementioned medical image analysis methods according to embodiments of the present invention can be implemented when the instruction codes are read and executed by a machine.

Accordingly, a memory medium for storing the program product in which computer-readable instruction codes are stored is also included in the present invention. The memory medium includes but is not limited to soft disc, optical disc, magnetic optical disc, memory card, memory stick and the like.

In the foregoing description on the specific embodiments of the present invention, the features described and/or shown for an implementation mode may be used in one or more other implementation modes in the same or like way or combined with the those of the other implementation modes, or replace those of the other implementation modes.

It should be emphasized that the terms ‘comprise/include’, as used herein, means the existence of a feature, element, action or component in a way not exclusive of the existence or addition of one or more other features, elements, actions or components.

In the aforementioned embodiments and examples, each action and/or unit is represented with a reference sign consisting of figures. It should be understood by those of ordinary skill of the art that the reference signs are merely intended to facilitate description and drawing but are not to be construed as a limitation on an order or any other aspect.

Furthermore, the methods provided in the present invention may be performed sequentially, synchronously or independently in accordance with another time sequences, not limited the time sequence described herein. Therefore, the implementation orders of the methods described in this specification are not to be construed as a limitation to the scope of the present invention.

Although the present invention has been disclosed with reference to specific embodiments herein, it should be understood that all the implementation modes and examples described above are merely illustrative of the present invention but are not to be construed as limiting the present invention. Various modifications, improvements or equivalents can be devised by those skilled in the art without departing from the spirit and scope of the invention, and such modifications, improvements or equivalents should be considered to fall within the scope of the present invention.

What is claimed is:

1. A medical image analysis apparatus, comprising:
an area motion analysis section configured to carry out a motion analysis on an area including an adjacent tissue of an object in a dynamic image to obtain the motion vector of the adjacent tissue; and
an object motion analysis section configured to determine the motion vector of the object based on the motion vector of the adjacent tissue.

2. The apparatus according to claim 1, wherein the object motion analysis section comprises a tangential motion component determination unit configured to determine tangential motion component of the object based on the motion vector of the adjacent tissue.

3. The apparatus according to claim 1, wherein the object motion analysis section comprises a radial motion component determination unit configured to determine radial motion component of the object based on the motion vector of the adjacent tissue.

4. The apparatus according to claim 2, wherein the object motion analysis section further comprises a radial motion component determination unit configured to determine the radial motion component of the object by carrying out motion analysis on the profile of the object.

5. The apparatus according to claim 1, wherein the area motion analysis section comprises an optical flow field calculation unit configured to carry out the motion analysis on the area by calculating continuous motion optical flow field of the area.

6. The apparatus according to claim 4, wherein the radial motion component determination unit is configured to carry out the motion analysis on the profile through feature tracking.

7. The apparatus according to claim 1, wherein the object comprises a moving organ.

8. The apparatus according to claim 1, wherein the object comprises myocardium of left ventricle.

9. The apparatus according to claim 8, wherein the adjacent tissue comprises the connection part of left ventricle and right ventricle, pericardium and/or papillary muscle.

10. The apparatus according to claim 4, wherein the object comprises the myocardium of left ventricle, and the radial motion component determination unit is configured to recognize endocardium and epicardium of the myocardium as the profiles.

11. The apparatus according to claim 8, further comprising a rotation strain determination section configured to determine rotation strain of the myocardium according to the motion vectors of basis cordis and apex cordis in the process of contraction and/or relaxation of the myocardium.

12. The apparatus according to claim 1, wherein the dynamic image comprises the one obtained in the manner of: magnetic resonance imaging, X-ray imaging, ultrasonic imaging, computed tomography or positron emission tomography.

13. A medical image analysis method executed by a medical image analysis apparatus, the method comprising:
carrying out, using the medical image analysis apparatus, a motion analysis on an area including an adjacent tissue of an object in a dynamic image to obtain the motion vector of the adjacent tissue; and
determining, using the medical image analysis apparatus, the motion vector of the object based on the motion vector of the adjacent tissue.

14. A medical imaging device, comprising a medical image analysis apparatus, wherein
the medical image analysis apparatus includes:
an area motion analysis section configured to carry out a motion analysis on an area including an adjacent tissue of an object in a dynamic image to obtain the motion vector of the adjacent tissue; and
an object motion analysis section configured to determine the motion vector of the object based on the motion vector of the adjacent tissue.
